(19) United States
(12) Patent Application Publication
(10) Pub. No.: US 2012/0269101 A1
(43) Pub. Date: Oct. 25, 2012

(54) LOCAL TRANSMISSION CANCELLATION FOR COMMUNICATIONS SYSTEM

(75) Inventors: Allen James Vexler, Rancho Santa Fe, CA (US); Jeffery Craig Lee, Poway, CA (US)

(73) Assignee: Mi Casa Software LLC, San Diego, CA (US)

(21) Appl. No.: 13/454,735

(22) Filed: Apr. 24, 2012

Related U.S. Application Data
(60) Provisional application No. 61/511,407, filed on Jul. 25, 2011.
(60) Provisional application No. 61/478,850, filed on Apr. 25, 2011.

(51) Int. Cl. H04L 5/14

(52) U.S. Cl. 370/276

(57) ABSTRACT

A system and method for transmitting Ethernet packets in full duplex mode over transmission medium such as a single coaxial cable or a twisted pair of wires by separating the signals by a receive amplifier that subtracts the transmit reference from the combined waveform contained on the coaxial cable.

### FIELD OF THE INVENTION

The present invention relates to communication lines, and more particularly, to transmitting Ethernet or any type of full duplex serial data on a single transmission line.

### BACKGROUND OF THE INVENTION

Currently available devices for transmitting Ethernet, or any full duplex serial data, over coaxial lines typically employ complex modulation methods, time division multiplexing (TDM) or frequency division multiplexing (FDM) to implement a network adapter capable for transmitting Ethernet signals across coaxial cables lines.

An example of a currently available device is disclosed by U.S. Pat. No. 7,548,549 that discloses time and frequency based isolation schemes for transmitting Ethernet over coaxial lines. These techniques result in devices and systems that are too complicated and expensive for this application.

Other modulation formats may be applied for combining and separating Ethernet signals. Code division multiple access (CDMA) could be applied for combining and separating Ethernet signals onto or off of, respectively, a single coaxial cable instead of TDM or FDM, but this format is complex and implementation would require costly development making use of these formats non-competitive.

In view of the foregoing discussion, there remains a need within the art for a device and method for the proper combining and separation of Ethernet transmit and receive signals other than more complex methods such as TDM, FDM, or CDMA that would be cost effective.

### SUMMARY OF THE INVENTION

In order to satisfy the above discussed needs within the prior art, embodiments are disclosed herein to combine the transmit signals from two separate sources onto one transmission line. Embodiments disclosed herein provide a simplified approach allowing for cost effective solutions, thus, providing competitive advantages for this application.

In an embodiment, isolation methods are applied based on a priori knowledge of the transmit signal before the waveform summation at the coaxial node or common node.

In another embodiment, a receiver may be made using prior knowledge of transmit signals to recover an Ethernet signal from a remote node retaining fidelity while viewing a combined complex waveform on the coaxial cable or general transmission line.

In another embodiment, a circuit subtracts the known local transmit signal from the combined signal leaving the remote transmit signal. Thus, a pair of circuits can be applied to end points of a coaxial cable enabling this separation technique to be used for successful transmission of Ethernet signals on a single transmission line.

Embodiments are discussed that provide for power over the transmission lines to power a dongle.

### BRIEF DESCRIPTION OF THE DRAWINGS

FIG. 1A is a block diagram for an embodiment;

FIG. 1B is a block diagram for another embodiment;

FIG. 1C is a block diagram of an embodiment for a passive dongle;

FIG. 2A is a schematic for an embodiment;

FIG. 2B is a signal diagram for the embodiment illustrated in FIG. 2A;

FIG. 3A is a schematic for another embodiment;

FIG. 3B is a signal diagram for the embodiment illustrated in FIG. 3A;

FIG. 4A is a signal diagram for another embodiment;

FIG. 4B is a schematic for the embodiment illustrated in FIG. 4A;

FIG. 5A is a schematic for another embodiment;

FIG. 5B is a signal diagram for the embodiment illustrated in FIG. 5A;

FIG. 6A is a schematic for another embodiment;

FIG. 6B is a signal diagram for the embodiment illustrated in FIG. 6A;

FIG. 7A is a schematic for another embodiment;

FIG. 7B is a schematic for the embodiment illustrated in FIG. 7A.

FIG. 8A is a schematic for another embodiment;

FIG. 8B is a schematic for the embodiment illustrated in FIG. 8A

FIG. 9 is a diagram illustrating providing power to dongles via a transmission line.

### DETAILED DESCRIPTION OF THE DRAWINGS

In order to satisfy the needs within the prior art, proper separation and combination of Ethernet transmit and receive signals may be accomplished by the below discussed embodiments either alone or in combination. These embodiments employ methods of selectivity that are simpler and more economically feasible than TDM, FDM or CMDA previously discussed.

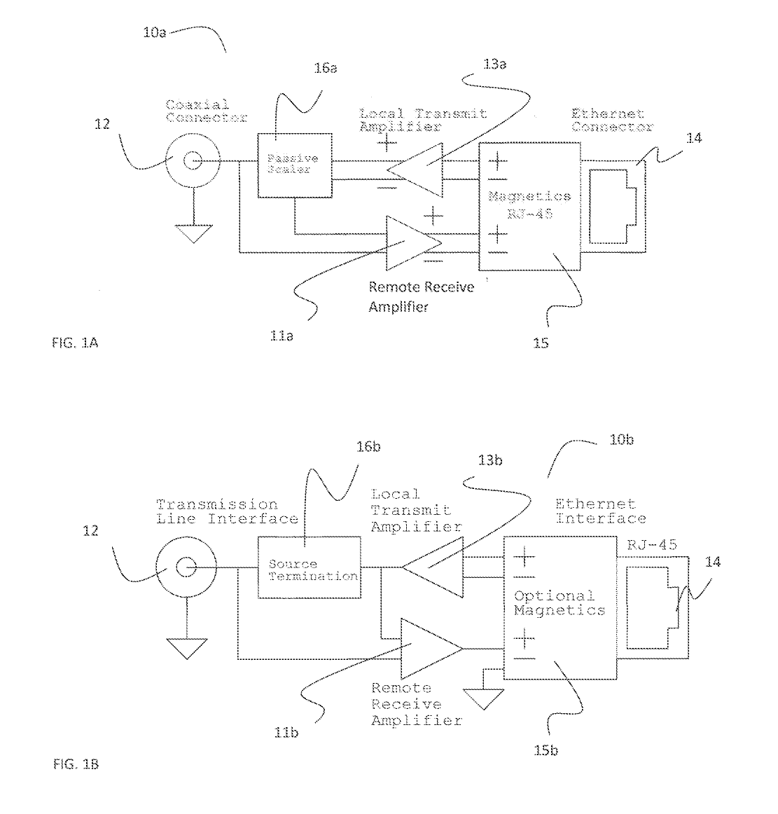

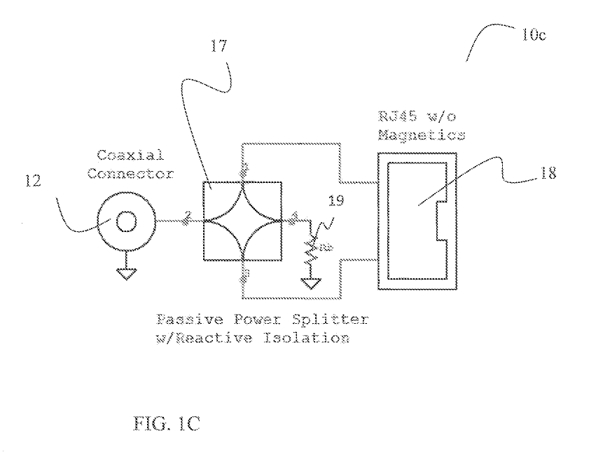

Referring to FIG. 1A, dongle 10a, allows 100 Megabit bidirectional Ethernet traffic over a single transmission line and connector 12 by subtracting the locally sensed transmit signal from the combined Ethernet signal at the transmission line interface. As used here, the combined signal refers to a combination of the Local Transmit Signal combined with the Remote Transmit Signal.

In an embodiment, security cameras may be replaced with Internet Protocol (IP) type cameras (such as CMOS Image sensor or a Charge Couple Device based camera) without having to replace the coaxial cable previously used with the previous analog camera. The new IP based camera typically requires an Ethernet connection, such as category 5 Ethernet. Dongle 10a allows data from the IP cameras to run over an existing coaxial cable thereby avoiding the cost of having to run new Ethernet cable for each new camera.

Embodiments are discussed herein that separate combined Ethernet transmit and receive waveforms by applying isolation methods based on a priori knowledge of the transmit signal as it existed before waveform summation at the single transmission line node. The priori knowledge of the transmit signal enables the design of receivers that can recover the Ethernet signal from the remote node while preserving fidelity by observing the combined complex waveform at the receiving end of the single transmission line. Embodiments may subtract the known local transmit signal from the combined signals leaving only the remote transmit signal. Thus a pair of circuits applying this separation technique at each end point allows for the Ethernet signals to be successfully transmitted across a transmission medium such as a single coaxial cable or a twisted pair of wires. The elegant simplicity of this approach allows for a cost effective solution for this application.

FIG. 1A is an architectural diagram for a dongle 10a that employs prior knowledge of the local transmit signal to enable a receiver to recover the remote Ethernet signal by observing the combined complex waveform at the receiving end of the transmission line at the connector interface. Signal connector 12 provides an interface between a transmission line, e.g. a coaxial cable (not shown) and the dongle 10. In an embodiment, the coaxial cable employed is a 75 ohm coaxial cable. Other embodiments may employ varying types of coaxial cable. It should be noted that any transmission line like a coaxial cable or twisted wire pair may be implemented using variations of the version of dongle 10a with minor modifications. It should also be noted that dongle 10a can be used with varying cable lengths. In an embodiment such as that illustrated in FIG. 1A, Ethernet connector 14 may be coupled to Ethernet optional magnetics 15 to interface the dongle 10a with an Ethernet cable (not shown). The optional Ethernet magnetics 15 can be used to provide electrical isolation and improved common mode rejection if an application requires these benefits. In one embodiment, a pair of dongles 10a will provide Input/Output support to enable Ethernet communications between two Ethernet connectors 14 to allow full duplex communications across a coaxial cable through coaxial connector 12 in accordance with IEEE 802.3 100 BASE-TX Ethernet, at up to 100 Mbps. All embodiments also support full duplex communications with the 10 Megabits per second (Mbps) Ethernet rate. It should be noted that embodiments automatically provide half duplex Ethernet communications if full duplex is not supported by either of the two attached Ethernet devices.

In an embodiment, Ethernet magnetics 15 may be used. Ethernet magnetics 15 can improve performance in the presence of common mode noise and provide electrical isolation. It should be noted that Ethernet magnetics may be used, but are not required and embodiments that do not implement Ethernet magnetics are also envisioned. The Ethernet magnetics 15 that may be used should be designed to support IEEE 802.3 applications. In some embodiments Ethernet connector 14 and Ethernet magnetics 15 may be integrated into a single device, in other embodiments the Ethernet connector 14 and Ethernet magnetics 15 are discrete elements. The passive scaler 16a taps off the local known transmit signal at the correct amplitude for subtraction by the remote receive amplifier 11a removing the local transmit signal from the composite waveform that is received at the Coaxial connector 12 input. The Local transmit amplifier 13a and the remote receive amplifier 11a illustrated in FIG. 1A have fully differential input and output amplifiers that require little or no external biasing. It should be noted that non-differential output amplifiers may also be used and embodiments implementing non-differential output amplifiers are envisioned. A power source may be derived from a Power Supply (not shown) contained externally from dongle 10a. Embodiments are also envisioned that have a self contained power source.

Embodiments employing an Ethernet connector 14 with magnetics 14 provide improved performance in situations with common mode noise. It should be noted that magnetics 15 are not required for functionality. Additionally, if simple operational amplifiers are utilized rather than fully differential input/output amplifiers the implementation can be further simplified as shown in FIG. 1B.

Referring to FIG. 1B, many of the elements are reproduced from FIG. 1A and have the same reference numeral. The passive scaler 16a in FIG. 1A is reduced to a source termination 16b in FIG. 1B which may be a resistor. In an embodiment, the resistance of source termination 16b may be equal to the resistance of the transmission line connected to dongle 10b. The input of the local transmit amplifier 13b may be terminated in 100 ohms and the remote receive amplifier 11b may include a source output resistance of 100 ohms (not shown). In the embodiment illustrated in FIG. 1B, the output of remote receive amplifier 11b is single-ended, but magnetics within the locally attached Ethernet device will convert the signal to differential form prior to entering the Ethernet physical receiver.

Alternatively, in embodiments in which the gain is scaled to accommodate losses, a passive dongle can be applied at one end of an Ethernet link removing the requirement for an external power adapter on one end of the link or utilizing a bias scheme with power over the coaxial cable to a remotely located unit. The tradeoff for only having one active dongle may be a reduction in the possible cable length.

FIG. 1C is an illustration of embodiment for a passive dongle 10c that may be placed at an end of an Ethernet connection. A passive power splitter 17 may be implemented. In some embodiments, passive power splitter 17 is a reactive power splitter that provides a high degree of isolation between the ports other than the common port. The passive dongle power splitter may have 4 ports. The ports that are 180 degrees apart provide isolation with power entering a port split between the two adjacent ports. Ethernet connector 18 and coaxial connector 12 are provided as shown in FIG. 1B. Rb is a resistor 19 that is used to provide a matched termination that balances impedances seen by the splitter. It should be noted that embodiments are envisioned having another coaxial connector attached to port 4 in place of Rb. The other coaxial connector makes it possible for the Ethernet device connected to the RJ45 of the dongle 10c to communicate with two other devices, thus having more than two Ethernet devices communicating across coaxial cable 12. Here, there is a limitation of being able to receive data from only one other dongle at a time to prevent data collisions. Accordingly, the two other devices should have a mechanism that only allows one of them to transmit at a given time to prevent data collisions. Other embodiments, may implement passive dongle 10c in varying ways. There are practical advantages to having two devices connected to a signal Ethernet device. For example, an Ethernet security camera could transmit video to two separate monitoring stations. Protocols can be used to only allow one of the devices to transmit to the Ethernet device.

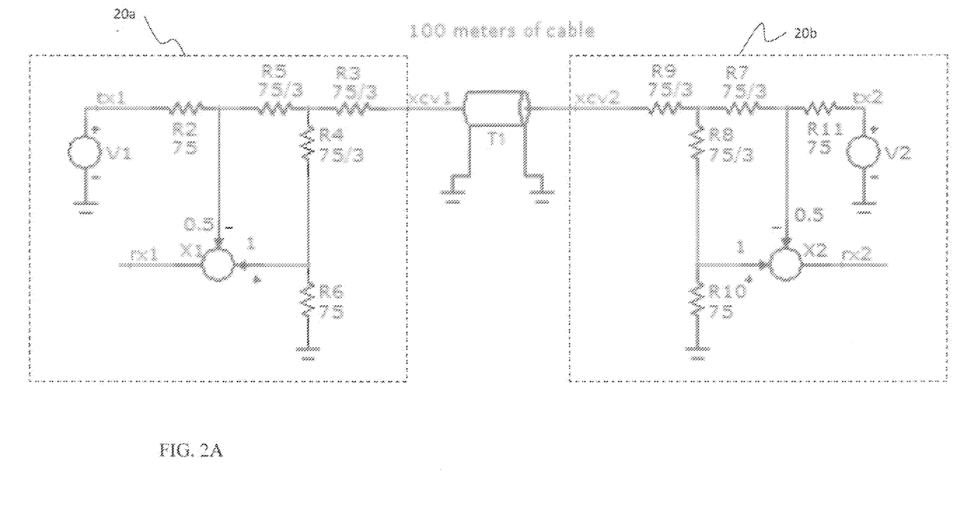

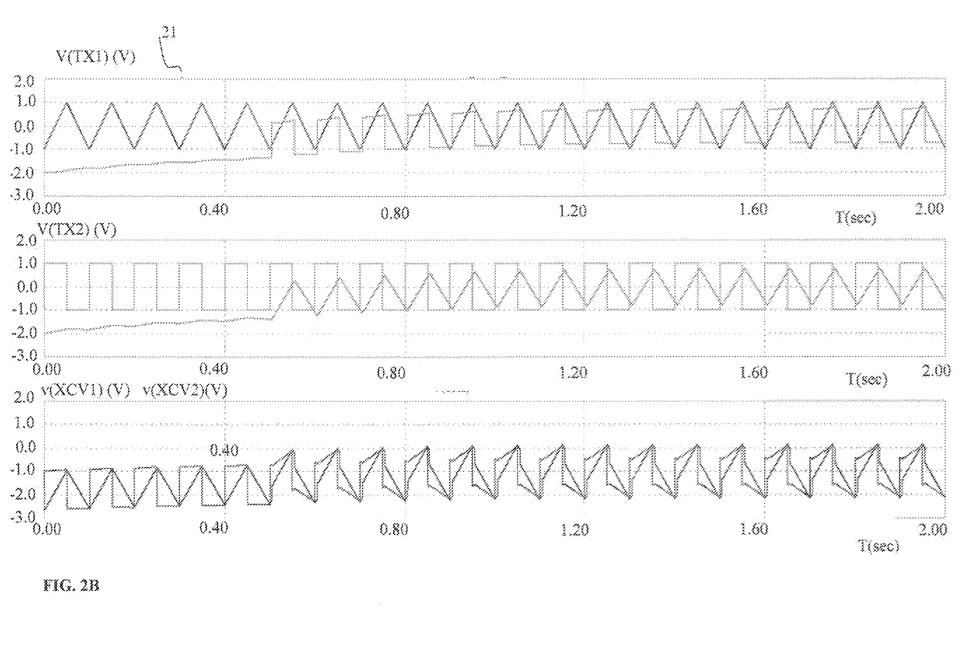

FIG. 2A is an idealized circuit for illustrating the transmission and reception of signals across a transmission medium T1. In FIG. 2A, the transmission medium T1 is a 100 meter length of coaxial cable, although it should be noted that differing lengths can be used, either longer or shorter, and that the transmission medium T1 may be over 1000 feet. Usage of transmission mediums besides coaxial cable is also envisioned, such as a pair of wires or a twisted pair. A pair of dongles 20a, 20b (shown by dotted lines), are similar to dongle 10a illustrated in FIG. 1A, and connected to either side of the coaxial cable used as transmission medium T1. The circuit elements left of transmission medium T1 in the schematic shown in FIG. 2A represent dongle 20a. The circuit elements in FIG. 2A right of transmission medium T1 represent dongle 20b. Signal separation device X1 is a receiving element for dongle 20a and X2 is a receiving element for dongle 20b. Signal generators V1 and V2 are simplified representations for the transmission portion of Ethernet or other serial communication circuit for dongles 20a, 20b, respectively. The signals are received at the opposite ends of transmission medium T1 as shown in FIG. 2B. Signal generators V1 and V2 as seen in FIG. 2A create signals that are transmitted across the transmission medium T1 to verify correct functionality of dongles 20a, 20b. In normal use signal generators, V1, V2 are buffer amplifiers for the signals coming from the Ethernet connectors that bring Ethernet signals into dongles 20a, 20b.

In discussing FIG. 2A, dongle 20a is viewed as local and dongle 20b is viewed as remote, unless otherwise stated. Thus signal generator V1 is representative of the local transmitter and signal generator V2 is representative of the remote transmitter. Separation device X1 is the local receiver and separation device X2 is the remote receiver. The received signal rx1 is produced by separation device X1 for dongle 20a receiving the local transmit signal as an input from signal generator V1 that is used to identify portions of the combined signal at node XCV1 that are to be removed by the separation device from the combined signal. The other input to signal separation device X1 is the signal from node XCV2 via transmission medium T1. Signal separation device X1 will remove the local transmit signal from signal generator V1 leaving only the signal produced by signal generator V2, thus producing signal rx1. Dongle 20b has signal separation device X2 that produces rx2 in a similar manner by removing the remote transmit signal produced by signal generator X2 thus producing signal rx2 for dongle 20b. Resistor R2 provides for the desired impedance matching and in the embodiment shown in FIG. 2A is 75 ohms for use with 75 ohm coaxial cable. It should be noted that embodiments implementing differing impedance matching techniques are envisioned. Resistor R11 provides similar impedance matching for dongle 20b that R2 provides for dongle 20a. Resistors R3, R4 and R5 are included for the purpose of balancing transmission line characteristics. Each of resistors R3, R4 and R5 provide for an impedance of ⅓ the value of the 75 ohm transmission line that is implemented in the embodiment illustrated in FIG. 2A. It should be noted that this resistor configuration is specific for the embodiment illustrated in FIG. 2A and that differing impedance matching configurations may be used with varying embodiments. The intent is that viewing the circuit impedance characteristics from node xcv1 towards voltage generator V1 and separation device X1 within dongle 20a, the impedance characteristics look substantially the same. Resistors R3, R4 and R5 are included for the purpose of transmission line characteristics. The resistors R7, R8 and R9 provide the same function for dongle 20b that resistors R3, R4 and R5 provide for dongle 10a within the embodiment illustrated in FIG. 2A with R9 providing the functionality of R3, R7 providing the functionality of R5 and R8 providing the functionality of R4.

In another embodiment, signal generators V1, V2 represent Ethernet signals that are received at an Ethernet connector and buffered by local transmit amplifiers (similar to Ethernet connector 14 and the local transmit amplifier 13a shown in FIG. 1A) to a dongle 20a, 20b and contain signals intended to be transmitted across transmission medium T1. In an embodiment, rx1 represents Ethernet signals that have the local transmit signal removed prior transmission through an Ethernet interface. For rx2 the remote transmit signal from signal generator V2 would be removed. In another exemplary embodiment, the transmission medium T1 is a coaxial cable. In yet another embodiment, the transmission medium is a twisted pair of wires. In an embodiment, remote receive amplifiers X1, X2 are differential amplifiers having one input used for the respective transmit signal of that dongle 20, 20b and another input used for the combined signal received across transmission medium T1.

Trace 21 in FIG. 2B illustrates signals seen at node TX1 in FIG. 2A. Trace 21 illustrates a triangle wave that originates from signal generator V1 in FIG. 2A and a square wave that originates from signal generator V2 in FIG. 2A. The square wave shows an amount of delay prior to being observed at node RX1 and it should be pointed out that this is shown to illustrate the uniqueness of separate signals generated by signal generators V1, V2 and not to be indicative of any actual Ethernet signal. Trace 22 illustrates the same signals shown in trace 21 only as seen from the perspectives at nodes TX2 and RX2 in FIG. 2A. Again in trace 22, a square wave originates from signal generator V2 and a triangle wave originates from signal generator V1 only now the apparent delay is seen in the triangle wave seen at node RX2 and again this is simply an illustration of the independence of the signals seen at the endpoints to transmission medium T1. Trace 23 is an illustration of an exemplary composite waveform containing the triangle wave and the square wave that originate from signal generators V1 and V2, respectively, and as viewed from node XCV1 and XCV2. The effect of the triangle wave and the square wave on each other is clearly evident in trace 23. The triangle wave and the square wave are respectively separated and cancelled by signal separators X1 and X2.

In trace 21, the triangle wave represents the local transmit signal and the square wave represents the remote transmit signal relative to signal generator V1 within dongle 20a. In trace 22, the opposite is true in that the square wave is the local transmit signal and the triangle wave is the remote transmit signal relative to signal generator V2 within dongle 20b.

The performance from a pulse fidelity perspective has been simulated using time domain analysis and simplified component models of the proposed functional design illustrated in FIG. 2A. The model and simulation results applying embodiments of isolation for the Ethernet to Coaxial adapter dongles 20a, 20b are shown in FIG. 2B. FIG. 2B illustrates that the triangular TX1 and square TX2 waveforms can be separated and independently recovered at their respective destinations RX2 and RX1 with sufficient fidelity through 100 meters of RG6 coaxial cable. In an embodiment, signal separators X1 and X2 are fully differential input and output amplifiers although it is not necessary to employ differential amplifiers with a balanced output.

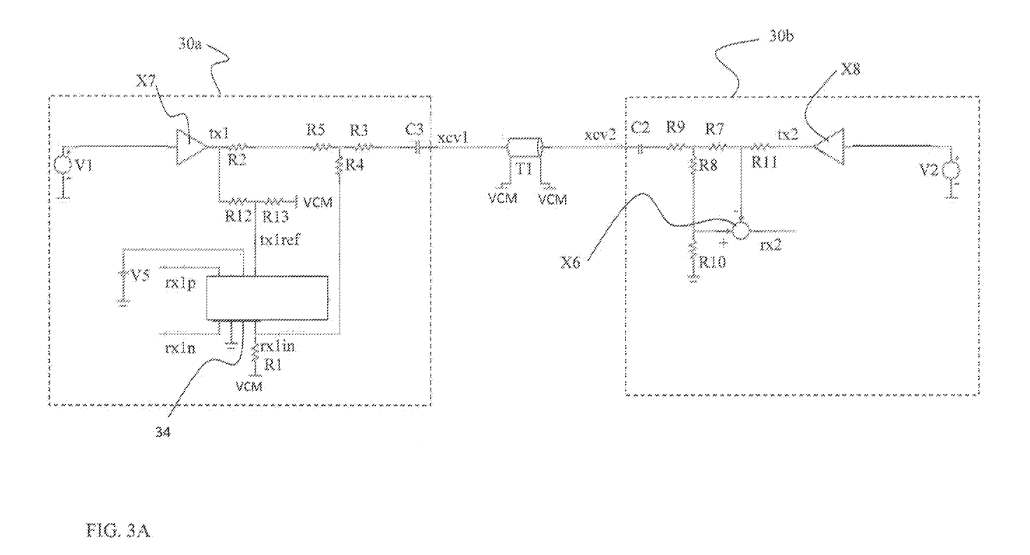

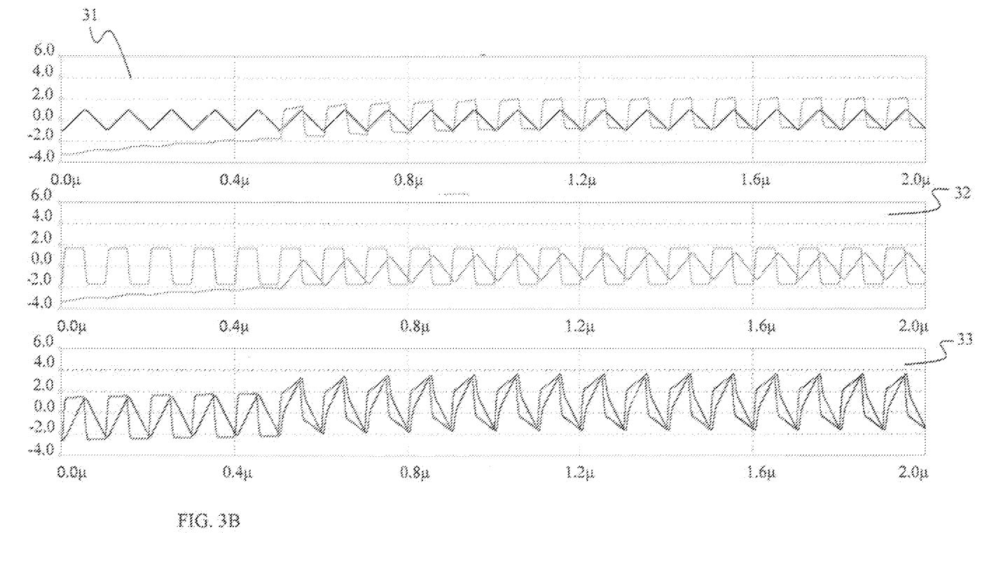

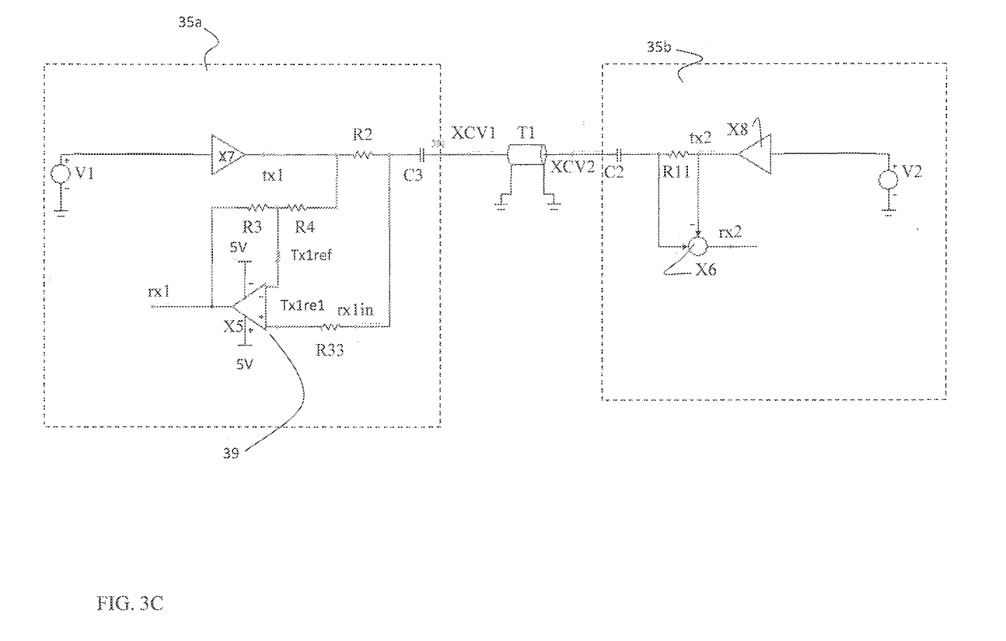

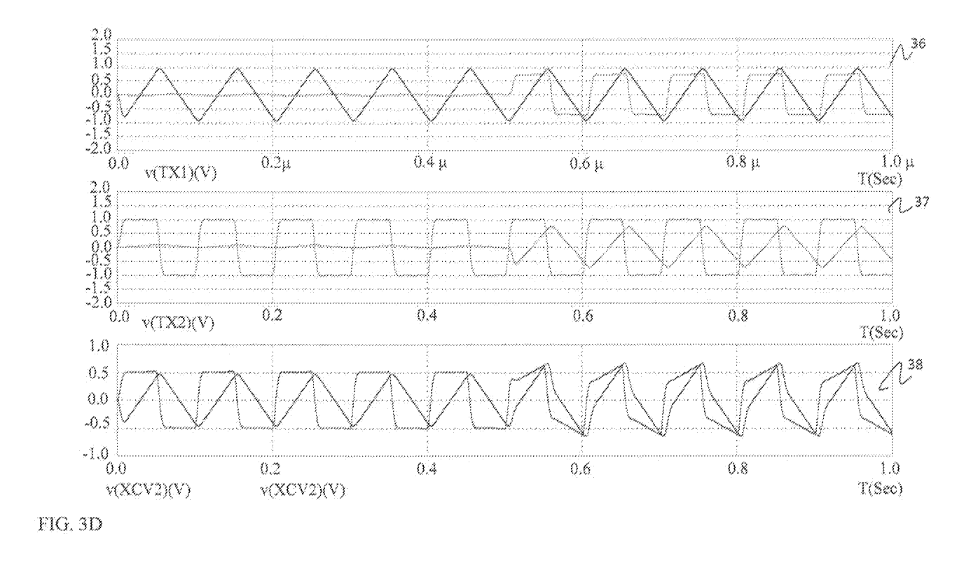

In another embodiment, an application is made of a receive amplifier that subtracts the local transmit reference from the combined waveform carried upon the coaxial cable. The performance of this amplifier determines the quality of the recovered signal fidelity. The embodiment illustrated in FIG. 3A and corresponding waveforms shown in FIG. 3B illustrate a circuit for combining and separating Ethernet signals onto/from a coaxial cable.

The embodiment shown in FIG. 3A is a communication system having local dongle 30a and remote dongle 30b that may be employed to combine, transmit, receive and separate Ethernet signals across a transmission medium T1, such as coaxial cables or twisted wire pairs. FIG. 3B is a diagram illustrating signals crossing transmission medium T1. Signal generator V1 represents the signal source coming from the Ethernet connector and amplifier X7 is the local transmitter amplifier that serves to buffer and amplify the output of signal generator V1 to provide the output to node TX1. Signal tx1ref in FIG. 3A is a scaled version of the output from amplifier X7 to be used as the local transmit signal feeding the inverting input of separation device 34. Separation device 34, in the embodiment shown in FIG. 3A, is a differential amplifier that may function as a local receiver. Signal rx1in is received by separation device 34 within the local receiver from the transmission medium T1. Signal rx1in has a component of tx1ref removed by separation device 34 to form received signal rx1 that is produced by differential outputs rx1p, rx1n of separation device 34. The output from separation device 34 is thus the signal contained at node XCV1 (rx1in) minus the local transmit signal (tx1ref). Signal generator V2 represents the signal source coming from the remote Ethernet connector and amplifier X8 is the remote transmitter amplifier that serves to buffer and amplify the output of signal generator V2 to provide the output to node TX2. Separation device X6 serves as the remote receiver and may also be a differential amplifier. Dongle 30b has signal separation device X6 that produces rx2 and removes the remote transmit signal produced by signal generator X8 from the signal contained at node XCV2.

FIG. 3B illustrates the signals at equivalent nodes as discussed in relation to FIG. 2A and FIG. 2B. Traces 31, 32, and 33 represented signals seen at equivalent nodes as previously discussed in relation to FIGS. 2A and 2B.

FIG. 3C illustrates another embodiment for a receive amplifier that subtracts the local transmit reference from the combined waveform carried upon the transmission medium T1 such as coaxial cable or twisted wire pair. The performance of this amplifier can determine the quality of the fidelity of the recovered signal. The embodiment in FIG. 3C illustrates a communication system having local dongle 35a and remote dongle 35b that may be employed to combine, transmit, receive and separate Ethernet signal across a transmission medium T1, such as coaxial cables or twisted wire pairs. FIG. 3D is a diagram illustrating signals crossing transmission medium T1. Signal generator V1 represents the signal source coming from the Ethernet connector and amplifier X7 is the local transmitter amplifier that serves to buffer and amplify the output of signal generator V1 to provide the output to node TX1. Signal tx1 in FIG. 3C is the output from amplifier X7 to be used as the local transmit signal to be input into the inverting input of separation device 39 via resistor R4. Resistors R3 and R4 are components supporting the scaling of the separation device 39. Resistor R33 is an optional component that may be used to optimize the recovered signal by Separation device 39 in the presence of non-ideal parasitic component properties. Separation device 39, in the embodiment shown in FIG. 3C, is a differential amplifier that may function as a local receiver. Signal rx1in is received by separation device 39 within the local receiver from the transmission medium T1. Signal rx1in has a component of tx1ref1 removed by separation device 39 to form received signal rx1. The output from separation device 39 is thus the signal contained at node XCV1 (rx1in) minus the local transmit signal (tx1ref). Signal generator V2 represents the signal source coming from the remote Ethernet connector and amplifier X8 is the remote transmitter amplifier that serves to buffer and amplify the output of signal generator V2 to provide the output to node TX2. Separation device X6 serves as the remote receiver and may also be a differential amplifier. Dongle 35b has signal separation device X6 that produces rx2 in a manner similar to the production of rx1 by dongle 35a by removing the remote transmit signal produced by signal generator X8 from the signal contained at node XCV2.

FIG. 3D illustrates the signals at equivalent nodes within FIG. 3A as previously discussed in relation to FIGS. 2A, 2B, 3A and 3B. The embodiment in FIG. 3C is built using amplifiers with lower cost single-ended outputs and lower cost power supply components. The embodiment of FIG. 3C employs a simple operational amplifier for the receive amplifier and the simulation results are shown in FIG. 3D. The qualitative performance of an actual prototype unit for the embodiment in FIG. 3C was measured after assembly yielding the results shown in Table 1. Note the distances listed in the table below are for dongles with local power supplies at each end and for a dongle pair that shares one power supply and remotely sends power over the coaxial cable (POC) to the second dongle. The table also shows performance verses various cable types and with a cable simulation device.

TABLE 1
Qualitative Performance: Direct Power/POC

| Ethernet | Direct Power | POC RG59 | Direct Power | POC RG6 | Direct Power | POC RG6 & |
|---|---|---|---|---|---|---|
| Mode | RG59 Feet | Feet | RG6 Feet | Feet | RG6 & RG59 Feet | RG59 Feet |
| 100BASE-TX | ~800 | ~700 | >1200 | >1200 | 1200 RG6 + | 1200 RG6 + |
| | | | | | 300 RG59 | 100 RG59 Marginal |
| | | | | | 1200 RG6 + | 1200 RG6 + |
| | | | | | simulator 300 | simulator 80 Marginal |
| 10BASE-TX | >1000 | >1000 | >1200 | >1200 | 1200 RG6 + | 1200 RG6 + |
| | w/simulator | | | | 500 RG59 | 500 RG59 |
| | >1200 | | | | 1200 RG6 + | 1200 RG6 + |
| | | | | | simulator 1000 | simulator 500 |

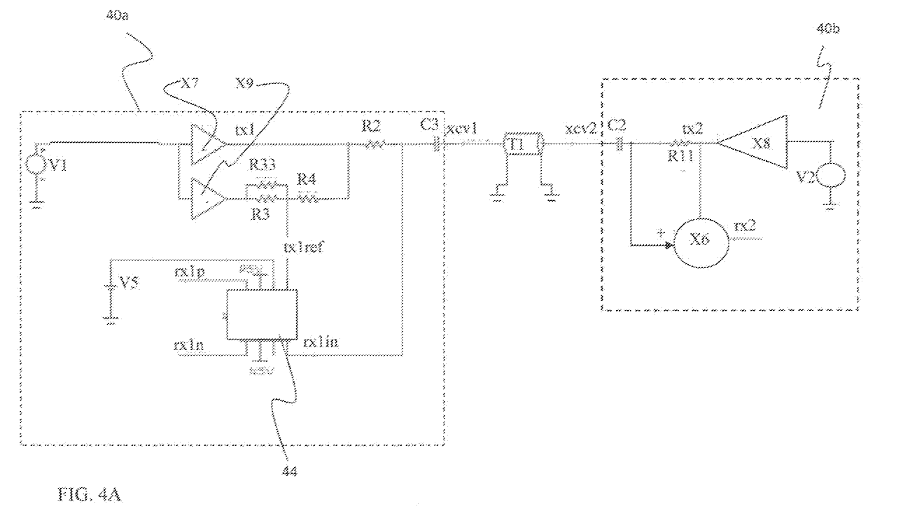

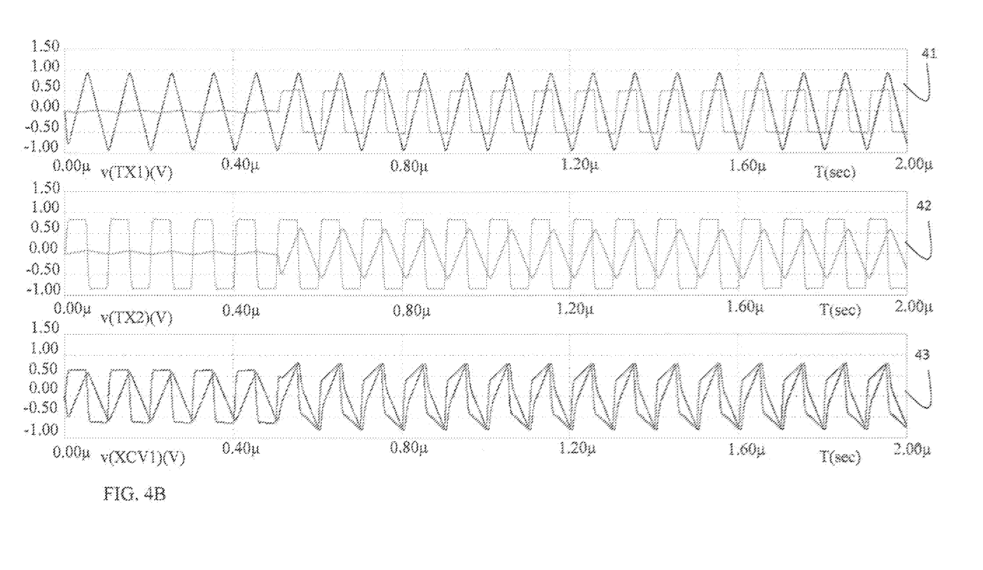

FIG. 4A is an illustration of an embodiment that scales and increases signal levels and thus reduces the required gain in the receive amplifier. FIG. 4B illustrates improved scaling that results from the circuitry applied in the embodiment shown in FIG. 4A.

The embodiment shown in FIG. 4A has been shown to be effective after simulation modeling to obtain functionality and extend cable length performance. Tests have been able to capture several images transmitted as video data streams using an IP Ethernet based camera documenting that functionality of the embodiment shown in FIG. 4A for various cable lengths. In addition standard Ethernet testers (Ethernet link analyzers) were used to test data transfer to verify the integrity of the video data stream. This demonstrates that the link was functional. FIG. 4B is a signal diagram that illustrates signals at equivalent nodes to the previously discussed embodiments crossing transmission medium T1.

The embodiment shown in FIG. 4A is a communication system having local dongle 40a and remote dongle 40b that may be employed to combine, transmit, receive and separate Ethernet signal across a transmission medium T1, such as coaxial cables or twisted wire pairs. Signal generator V1 represents the signal source coming from the Ethernet connector and amplifiers X7, X9 is the local transmitter amplifier that serves to buffer and amplify the output of signal generator V1 to provide the output to node. Signal tx1ref in FIG. 4A is a version of the output from amplifier X9 may be used as the local transmit signal to be input into the inverting input of separation device 44. Separation device 44, in the embodiment shown in FIG. 4A, may be a differential output amplifier functioning as a local receiver but it is not necessary that separation device 44 be a differential output amplifier. Signal rx1in is received by separation device 44 within the local receiver from the transmission medium T1. Signals rx1in has a component of tx1ref removed by separation device 44 to form received signal rx1 that is produced by differential outputs rx1p, rx1n to separation device 44. The output from separation device 44 is thus the signal contained at node XCV1 (rx1in) minus the local transmit signal (tx1ref). Signal generator V2 represents the signal source coming from the remote Ethernet connector and amplifier X8 is the remote transmitter amplifier that serves to buffer and amplify the output of signal generator V2 to provide the output to node TX2. Separation device X6 serves as the remote receiver and may also be a differential amplifier. Dongle 40b has signal separation device X6 that produces rx2 in a similar manner by removing the remote transmit signal produced by signal generator X8 from the signal contained at node XCV2.

FIG. 4B shows signals at equivalent nodes to the previously discussed embodiment in FIG. 2A and FIG. 2B. Therefore, traces 41, 42 and 43 are signals seen at equivalent nodes as traces 21, 22 and 23.

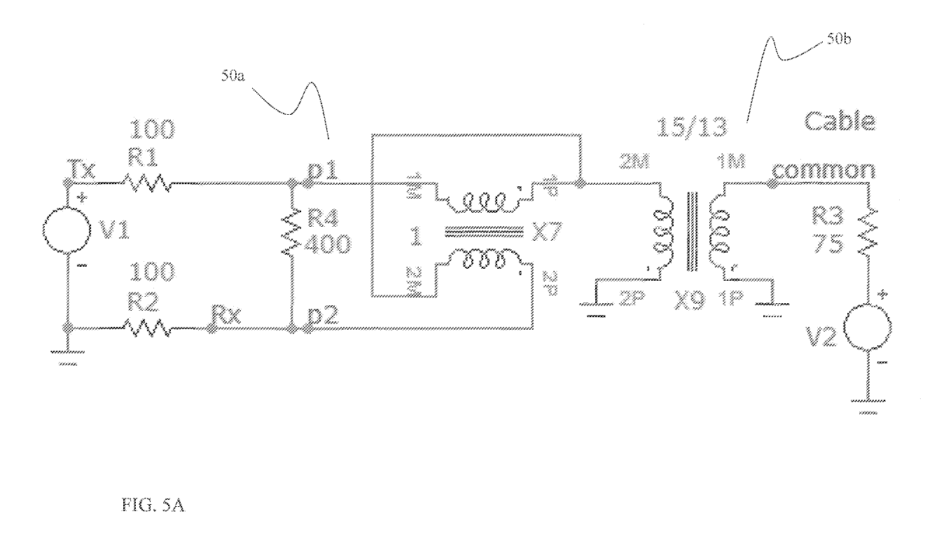

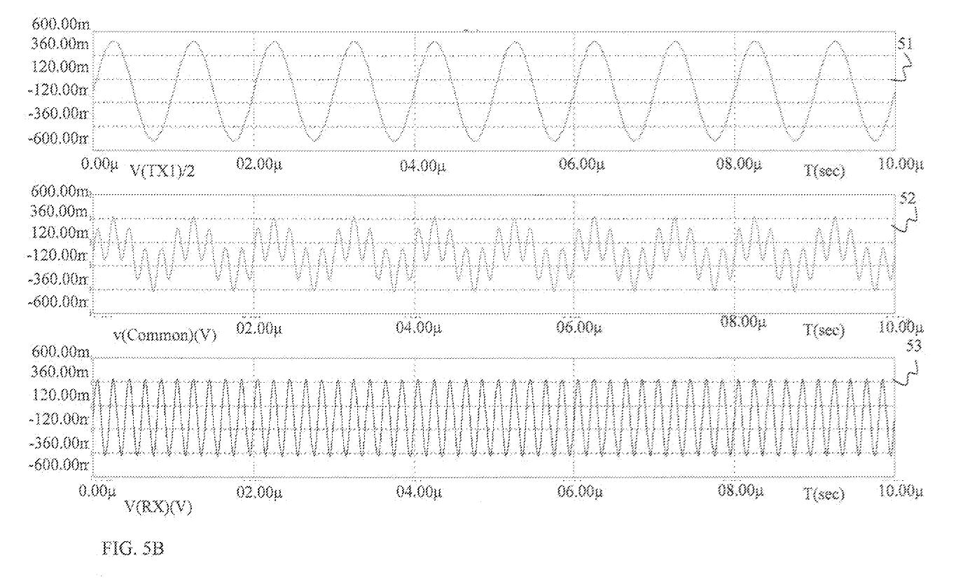

FIG. 5A is an embodiment employing a passive dongle 50a to replace one of the dongles illustrated in the previous active embodiments. While dongle 50a is a passive dongle, dongle 50b may be one of the active dongles previously discussed and located at the opposite end of a transmission medium indicated as the node labeled common. In FIG. 5A passive dongle 50a is used in combination with an active dongle like 10a or 10b. As used herein, passive refers to a dongle that does not require an external power supply source. An active dongle such as 10b is shown as signal source V2 and resistor R3 for illustrative purposes and referred to as dongle 50b, but may be similar to any of the previously discussed dongles. There are numerous embodiments that can implement an isolated passive splitter to route signal power from the active dongle to the receive port P2 in the passive dongle 50 while simultaneously providing isolation from V1, a local Ethernet transmit signal entering on P2. In FIG. 5B, a system simulation for basic functions of the passive dongle 50a used with an active dongle 50b is shown.

The passive dongle 50a may be based on a single transformer splitter X7. In FIG. 5A, in order to match splitter to 75 ohms another transformer X9 is added on the output of the common port designated by the node labeled common. Schematically, transformer X9 is shown as a two winding transformer, however, in actual implementation a tapped inductor functioning as an autotransformer may be used instead.

In FIG. 5B, trace 51 illustrates observed signals at node Tx which is the local transmit signal, trace 52 shows observed signals at node common and trace 53 shows observed signals at node Rx. The signal shown in trace 53 illustrates that the signal shown trace 52 (seen at the node common) effectively has the local transmit signal (trace 51) removed from the signal observed at trace 53, thus providing a cost effective manner of transmitting Ethernet signals across a transmission medium.

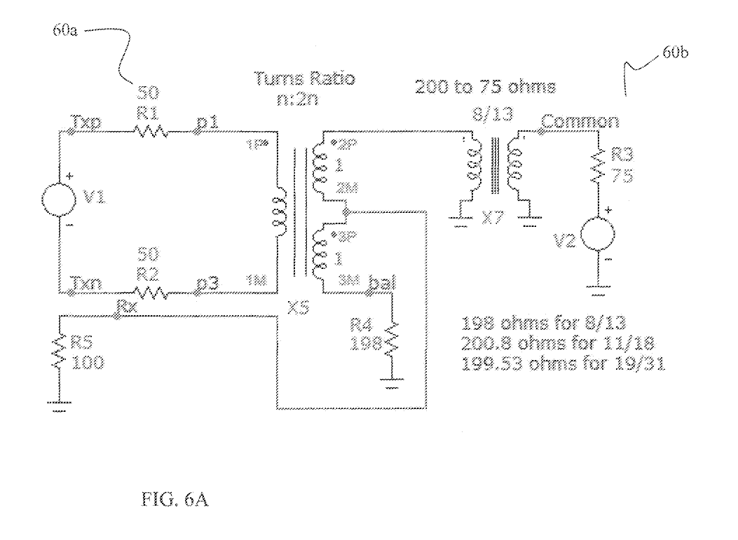

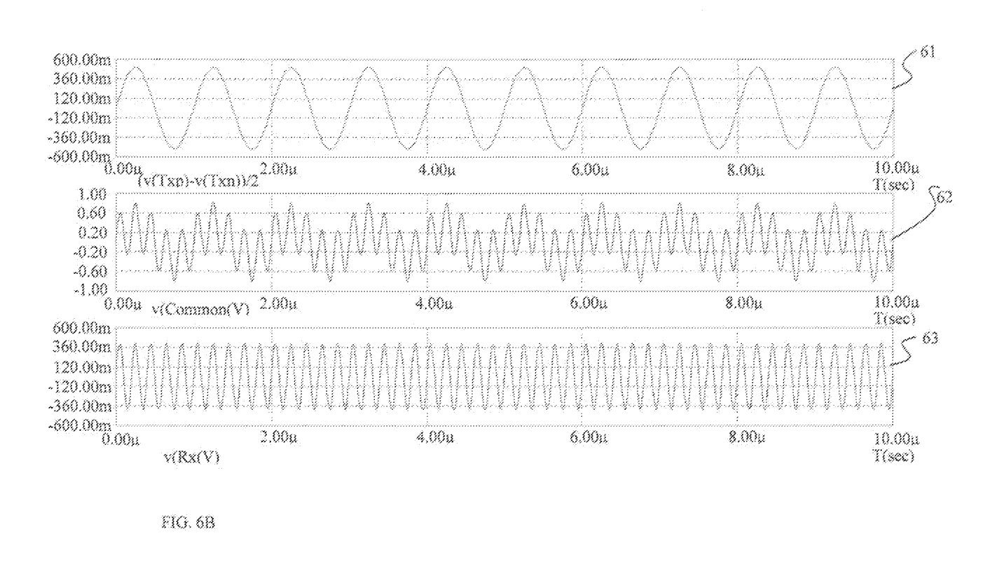

FIG. 6A is another embodiment for a passive dongle 60a. The splitter in this embodiment may be based on a center-tapped transformer X5. Again the output is matched to the 75 ohm cable with an additional transformer that could be an autotransformer.

The embodiment shown in FIG. 6A employs two cores, providing better isolation as confirmed in simulation at the expense of requiring a slightly more expensive center-tapped transformer X5.

In FIG. 6B, trace 61 illustrates observed signals at nodes Txp and Txn which is the differential local transmit signal, trace 62 shows observed signals at node common and trace 63 shows observed signals at node Rx. The signal shown in trace 63 illustrates that the signal shown at the node common in trace 62 effectively has the local transmit signal removed from the signal observed at trace 63, thus providing a cost effective manner of transmitting Ethernet signals across a transmission medium.

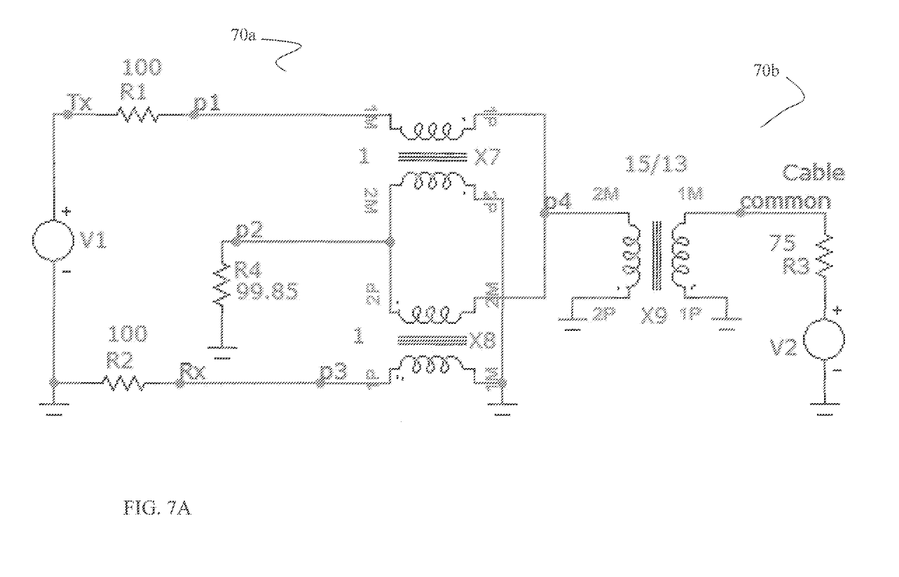

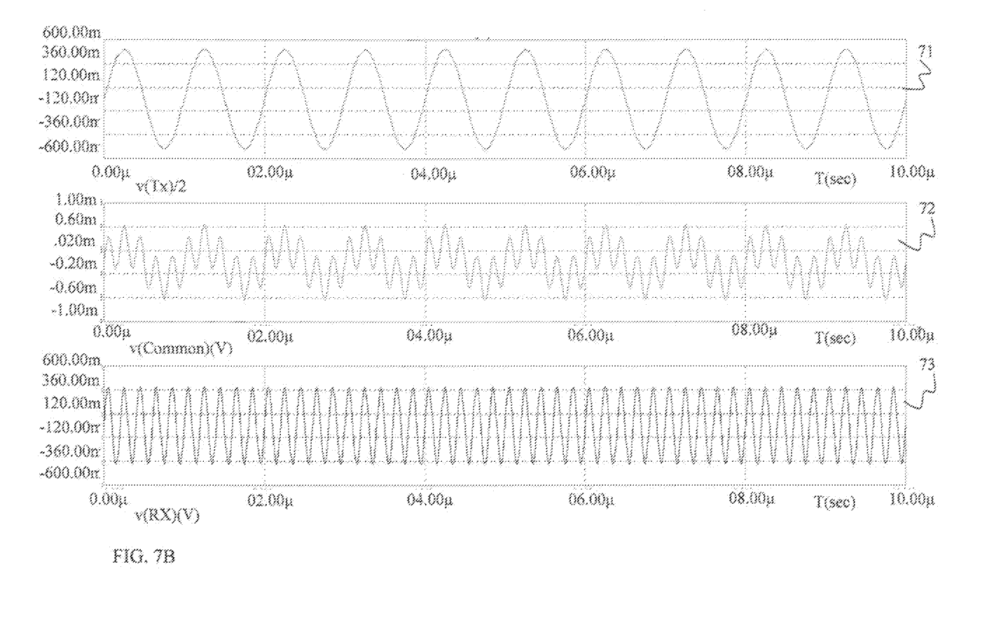

FIG. 7A illustrates another embodiment for a passive dongle splitter that may be based on a two transformer X7, X8 splitter topology. Again the splitter output is matched to the 75 ohm cable with an additional transformer. The embodiment illustrated in FIG. 7A employs three cores, slightly increasing cost over the passive dongle embodiment of FIG. 6A but providing better isolation as confirmed in measurements of traces 71, 72, 73 shown in FIG. 7B.

FIG. 7B trace 71 illustrates observed signals at node Tx which is the local transmit signal, trace 72 shows observed signals at node common and trace 73 shows observed signals at node Rx. Trace 73 illustrates that the signal shown at the node common in trace 72 effectively has the local transmit signal removed from the signal observed at trace 73, thus providing a cost effective manner of transmitting Ethernet signals across a transmission medium.

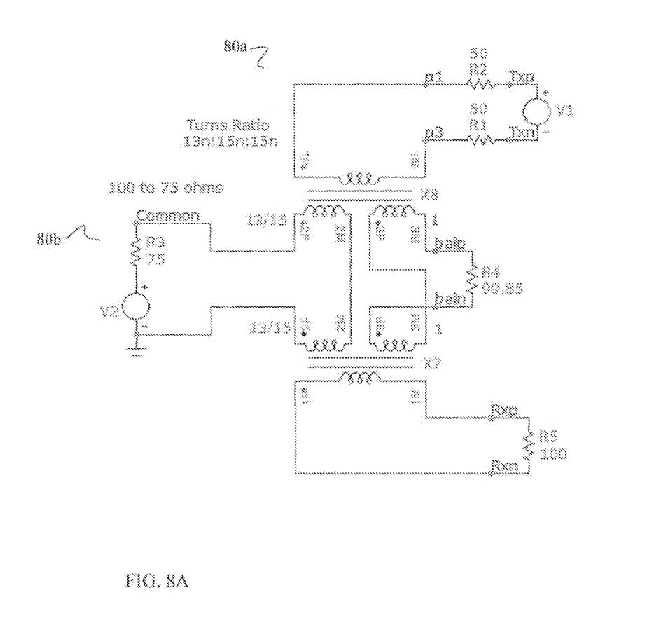

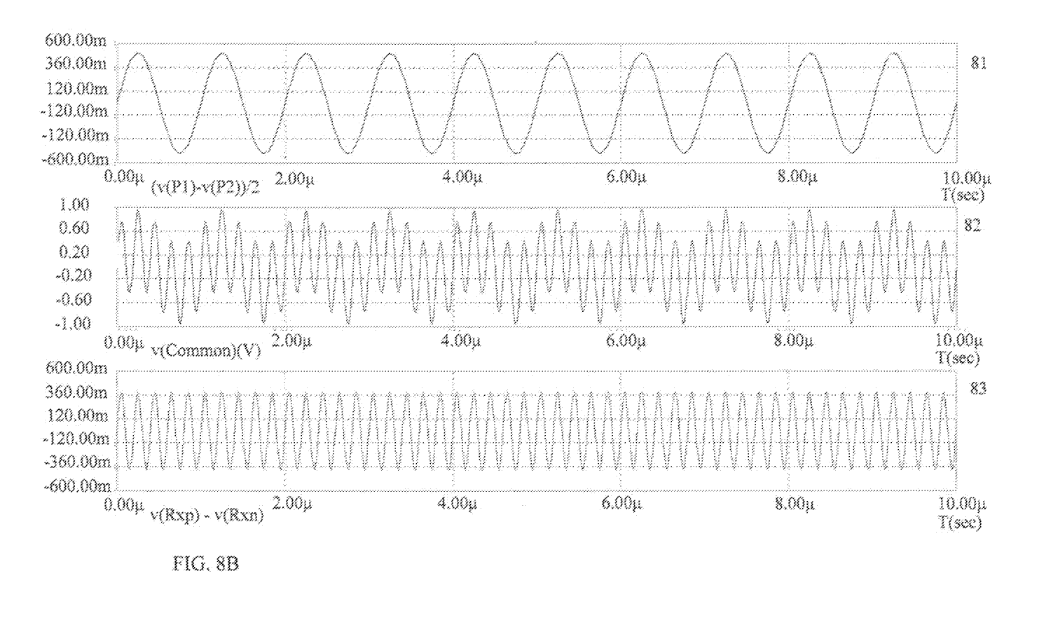

FIG. 8A illustrates another embodiment for a passive dongle splitter based on a two transformer X7, X8 balanced topology. The embodiment shown in FIG. 8A has the output matching to 75 ohms that may be built into the splitter function eliminating a need for an additional transformer.

In FIG. 8B, trace 81 illustrates the voltage level of observed signals in dongle 80a one half the voltage level of nodes P1 and P3 which is the local transmit signal, trace 82 shows observed signals at node common and trace 83 shows observed voltage levels for the difference in signals at nodes Rp and Rn. Trace 83 illustrates that the signal shown at the node common in trace 82 effectively has the local transmit signal removed from the signal observed at trace 83, thus providing a cost effective manner of transmitting Ethernet signals across a transmission medium.

The embodiment shown in FIG. 8A has the cost advantage of requiring only two cores, but provides better isolation than the embodiment shown in FIG. 6A, thereby, providing a tradeoff in the design of dongles for the transmission of Ethernet signals across transmission mediums. Results are similar to those in FIG. 7A but at a conceivably lower cost assuming two cores each with three windings is less expensive then 3 cores each with two windings. The fully balanced topology may also provide some performance benefits from external common mode noise.

In an embodiment, coaxial cable run lengths of 100 Meters or more using RG-59 or better are implemented using a dongle 10 at either end of the cable to interface an Ethernet cable that is connected to each dongle 10 and provide a full duplex Ethernet interface between each Ethernet connector across the coaxial cable.

Embodiments can be constructed that have a power consumption of less than 0.4 watts while drawing a current of less than 30 milliamperes (mA) at a potential energy level of 12V or less. It should be noted the embodiments having a power consumption of equal to or greater than 0.4 watts are also envisioned. Power sources in embodiments may be external standard linear or switching regulated supplies. It should be noted that embodiments are envisioned the draw less than 30 milliamperes at 12V and require less than 0.4 watts to operate. Embodiments employing power conversion from an AC outlet or a DC input of the dongles are also envisioned.

Embodiments are envisioned that will maximize functionality to ensure proper performance while controlling cost. For example, embodiments are envisioned that may use no more than a 2 layer Printed Wire Board (PWB). It should be understood that the above discussed features are not requirements and only examples of embodiments that may be implemented to assist in optimizing Bill of Material (BOM) costs.

In other embodiments, dongle 10 may be intended to be used with extended coaxial cable lengths, an equalizer for that purpose may be added to the Ethernet to Coaxial adapter dongle 10.

In an embodiment the local transmit amplifier and the remote receive amplifiers are differential input and output types with sufficient bandwidth to reproduce 100 Megabit Ethernet with good fidelity. It should be noted that the output of the amplifier does not have to be differential. In an embodiment, the shield for the coax cable is placed at the same potential as the common potential for the local transmit and remote receive amplifiers. In another embodiment, the common potential for the local transmit and the remote receive amplifiers is not connected to the shield for the coax cable, but instead, the drive for the differential signal is provided by a twisted cable pair.

In an embodiment, there are no special biasing requirements as the amplifiers set their own operating points. The only external bias applied is a mid supply reference to the amplifiers which is needed since the lowest cost implementation may only use one power supply voltage. This “external bias” may be only external to the amplifiers to set an operating point within the common mode range and is generated locally from the power supply. Another embodiment implements both positive and negative supplies, and in such systems ground potential could serve that purpose of the mid supply reference.

An embodiment provides a method for powering a device connected with coax using either Power over Ethernet (PoE) or a Power Adapter as the source of power.

A method for simultaneous, bi-directional transmission of 10/100 Megabit Ethernet signals over a coax cable by placing a dongle converter at each end of the coax cable. The power for the dongles may be supplied in a number of ways. A separate power adapter may be employed for each dongle. This implementation requires two power adapters. Alternatively, a dongle arrangement may be configured having a power adapter for one dongle with that dongle sending power for the remote dongle over the coax. This implementation only requires one power adapter.

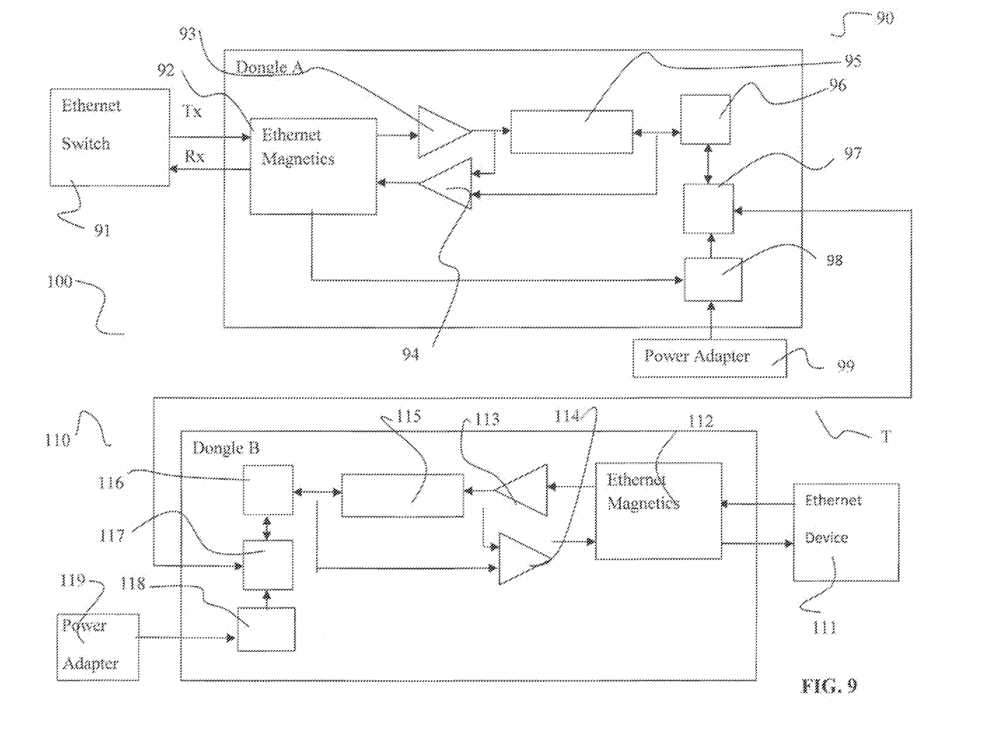

Referring to FIG. 9, an arrangement 100 of a pair of dongle arrangements 90, 110 is illustrated for providing PoE. Dongle A, generally referred to as 90, may have Ethernet magnetics 92 interface between Ethernet switch 91 and transmission amplifier 93 and receiving amplifier 94. Source termination 95 couples transmitted signals from transmission amplifier 93 as well as received signals from DC Block 96 to receiving amplifier 94. Signal & Power Combiner 97 receives signals to be transmitted from DC Block, 93 combines these signals with power and places to signals to be transmitted with power onto the transmission line T, which may be a coax cable or a twisted wire pair. Power source selector 98 will receive power to be combined with signals. This power may come from Ethernet switch 91 via Ethernet magnetics 92 if the Ethernet switch supports PoE. If the Ethernet switch does not support PoE, then Power Adapter 99 provides the power to the Power source selector 98.

Still referring to FIG. 9, arrangement 100 further illustrates dongle B, generally referred to as 110. Dongle B 110 may have Ethernet magnetics 112 that interfaces Ethernet switch 111 with transmission amplifier 113 and receiving amplifier 114. Source termination 115 couples transmitted signals from transmission amplifier 113 as well as received signals from DC Block 116 to receiving amplifier 114. Signal & Power Splitter 117 receives signals from transmission line T and splits these signals from the power that is contained on transmission line T. The signals are then provided to DC Block 116 which routes these signals to Source Termination 115 and to receiving amplifier 114. Source termination adjusts the received signals and routes the adjusted version to the receiving amplifier 114. Power source selector 118 receives power from the Signal & Power Splitter 117 if power over transmission line T (coax or twisted wire pair) is supplied. Power adapter 119 may be implemented to supply power in embodiments that do not provide power over transmission line T for Dongle B 110. Power source selector 118 then routes power to Ethernet Magnetics 112. The Ethernet device 111 will receive the Ethernet signals and transmit Ethernet signals that are combined with power. Ethernet device 111 will provide signals to be transmitted by Dongle B 110, these signals are combined with power. The signals to be transmitted are then routed to Ethernet Magnetics 112 which routes them to transmission amplifier 113 which routes them to source termination 115. DC Block 116 inputs the signals to be transmitted from Source termination 115 and sends them to Signal Power & Splitter 117 where they are placed on the transmission line T.

Ethernet supports the ability to power a remote device using PoE. Power is provided by a PoE compatible power sourcing equipment (PSE) like a Switch or Midspan power injector, which sends a maximum of +57V at 600 mA over spare wires on the Cat5/6 Ethernet cable. PoE allows a remote device called a powered device (PD) to obtain power from the same Cat5/6 cable that the Ethernet signals are on, thereby eliminating the need for a separate power source for the remote device.

### PoE Compatibility

The proposed system powers the remote dongle and Ethernet device. Both PoE compliant and non-compliant devices can be powered. The local and remote dongles are also powered from the PSE and appear as transparent parasitic loads on the PSE. In order for the dongles to appear transparent to the PSE and thus not interfere with the PSE to PD communications, the power consumption of the dongles are delayed until the communications are complete and power is enabled on the port. Power may be provided to the remote side using a number of implementations, two of which are described below. PoE with a PSE device (PoE Switch or Midspan power injector) as Power Source (See FIG. 1): Power provided by a PoE compatible PSE device enters the first dongle via the same connector as the Ethernet signals and is combined with those signals in order to be sent over the coax. The receiving dongle will separate the Ethernet related signals and power and then send the power out the Ethernet connector to the PoE peripheral called the powered device (PD). Additionally, PoE without a PoE PSE device as Power Source (See FIG. 2): PoE compatible power levels can still be generated for a PoE peripheral, even if there is no PoE PSE to provide power. This is accomplished by the following: (1) the Power Adapter provides power instead of the PoE PSE. The Power Adapter is plugged directly into the dongle providing the power. (2) Power from the Power Adapter is converted to PoE compliant levels as required and sourced to the PD using a standard PoE PSE Controller. (3) The Power Adapter or dongle may include the PoE PSE Controller. Only one PSE Controller is required or allowed to be active.

A number of elements may be used with the dongles to implement PoE compatibility. First, the addition of signal connections to the Ethernet jack in order for the PoE power signals to be routed on the dongle board and second, adding a Power Source Selector to inject power from the PSE device or external Power Adapter. The Power Source Selector will include a local power regulator for the dongle electronics. If not included in the Power Adapter, adding a PoE Power Sourcing Controller between the Power Adapter and Power Source Selector allows for injecting PoE compliant power that may be used to power PoE compliant remote devices.

1. A communication system comprising a device:
a first connector arranged for a first transmission format, wherein the first transmission format has a first number of transmission lines;
a second connector arranged for a second transmission format, wherein the second transmission format has a second number of transmission lines wherein the second number of transmission lines is less than the first number of transmission lines;
a first circuit operatively connected to both the first connector and the second connector that combines signals in the first transmission format at the first connector to the second transmission format at the second connector; and
a second circuit operatively connected to both the first connector and the second connectors, the second circuit separating signals received in the second transmission format into the first transmission format, wherein the second circuit employs prior knowledge of at least one signal within the first transmission format to separate signals received at the second connector in the second transmission format into signals of the first transmission format at the first connector.

2. The system of claim 1 further comprising a pair of the devices operatively connected through a transmission line that carries signals in the second transmission format, wherein the transmission line is connected to the second connector of each of the pair of the devices.

3. The system of claim 1 wherein the first transmission format contains a pair of independent signal paths and the second transmission format contains a single independent signal path.

4. The system of claim 1 wherein the first transmission format further comprises a local transmit signal and a remote transmit signal and the second circuit separates signals within the second transmission format into the first transmission format using prior knowledge of the local transmit signal to subtract the local transmit signal from signal received to acquire the remote transmit signal.

5. The system of claim 4 wherein the second circuit includes a directional isolator with prior knowledge of the local transmit signal to separate signals within the second transmission format into signals of the first transmission format.

6. The system of claim 1 wherein the system is adapted to provide full duplex transmission of Ethernet communications traffic over a coaxial cable.

7. The system of claim 1 wherein the first circuit and the second circuit employ amplifiers having differential inputs and outputs with sufficient bandwidth to reproduce 100 Megabit Ethernet.

8. The system of claim 1 wherein the first circuit and the second circuit each comprise amplifiers that do not have differential outputs.

9. The system of claim 1 wherein external bias is applied from a mid supply reference to the amplifiers received from an external supply voltage.

10. The system of claim 1 wherein bias for the amplifiers is supplied from the systems ground.

11. A method for transmitting Ethernet signals across transmission mediums comprising:
transmitting Ethernet signals from a first end of a transmission medium to a second end of the transmission medium;
detecting a series of Ethernet signals at the second end of the transmission medium;
and removing a portion of the series of Ethernet signals detected at the second end of the transmission medium that are being transmitted from that second end towards the first end to acquire a received signal at the second end.

12. The method of claim 11 wherein the portion of the series Ethernet signals removed at the second end are signals that are detected at the first end.

13. The method of claim 12 further comprising detecting a second series of Ethernet signals at the first end and removing a portion of the second series of Ethernet signals detected at the first end.

14. The method of claim 13 wherein the portion of the second series of Ethernet signals removed at the first end are signals that are detected at the second end.

15. The method of claim 11 wherein transmitting further comprises transmitting across a coax cable as the transmission medium.

16. The method of claim 11 wherein transmitting further comprises transmitting across a pair of wires as the transmission medium.
